(19) United States
(12) Patent Application Publication
(10) Pub. No.: US 2004/0025182 A1
(43) Pub. Date: Feb. 5, 2004

(54) Method, system and computer readable medium for a raido communication processing unit

(75) Inventors: Kazuyoshi Tari, Omiya-shi (JP); Hiroyuki Unoki, Omiya-shi (JP); Tumoru Nagira, Omiya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI MATERIALS CORPORATION, Tokyo (JP)

(21) Appl. No.: 10/629,622

(22) Filed: Jul. 30, 2003

Related U.S. Application Data
(63) Continuation of application No. 09/479,621, filed on Jan. 7, 2000.

(30) Foreign Application Priority Data
Jan. 7, 1999 (JP) HEI. 11-002359

(51) Int. Cl. H04N 5/445; H04N 7/173; H04B 1/10

(52) U.S. Cl. 725/61; 725/115; 455/222

(57) ABSTRACT

A method, system and computer readable medium for a wireless radio communication processing unit capable of, when setting or changing a communication frequency to be used in one of base station wireless radio units, setting a frequency which does not interfere with communication frequencies being used in other base station wireless radio units. In the wireless radio communication processing unit, when a power supply is turned on, when the unit is reset, or a fault detection section detects a fault resulting from an interfering wave or the like in a communication area of the base station wireless radio unit, a station information requesting section inquires for a channel being used in a base station wireless radio unit that a different wireless radio communication processing unit manages. A channel information editing section updates information in a channel information storage section, while, on the basis of the updated information, a channel setting section gives, to the base station wireless radio unit on which the fault is detected, an instruction for changing to a communication frequency which does not interfere with the communication frequencies being used in different base station wireless radio units.

### BACKGROUND OF THE INVENTION

1. Field of the Invention

The present invention relates to a method, system and computer readable medium for a wireless radio communication processing unit which controls data communications made by wireless radio between a mobile terminal and a host server connected to a network in a state where base station wireless radio unit(s) intervenes therebetween and which manage/control the frequencies for use in wireless radio communications between the base station wireless radio unit and the mobile terminal.

2. Discussion of the Background

In recent years, with a rise in the needs for mobile computing, various radio communication (i.e., the wireless transmission through space of electromagnetic waves, for example, in the frequency range from 10 kHz to 300,000 MHz) network systems have been proposed for realizing a mobile computing environment. Some of these systems are made up of, for example, user side mobile terminal(s) (hereinafter referred to as “mobile terminal(s)”) for conducting transmission/reception of data by virtue of radio communication, a plurality of servers connected to a network, and a base station radio unit(s) connected to these servers for transferring data, transmitted from the mobile terminal by radio communication, to the server and further for transmitting data, directed to the mobile terminal from the network side, through the server to the addressed mobile terminal by radio communication.

However, in such radio communication network systems, within a communication area of each of a base station radio units, communication frequencies for use in communications with mobile terminals may interfere with the communication frequencies used within communication areas of different base station radio units. For example, let it be assumed that, as shown in, for example, FIG. 7(a), a mobile terminal ML exists in a place where the communication areas A, B and C of three base station radio units BS1, BS2 and BS3, respectively, overlap with each other. In this situation, if a frequency f1 that the base station radio unit BS1 uses is extremely close to a frequency f2 the base station radio unit BS2 uses (for example, |f1−f2|=12.5 kHz), high-order distortion typically occurs in the frequency spectrum the mobile terminal ML receives because of the non-linearity of a receiving circuit or the like in the mobile terminal ML, as just shown in, for example, FIG. 7(b).

Similarly, in a case where the base station radio unit BS3 makes a communication with the mobile terminal ML within its own communication area C at a frequency f3=|mf1±nf2| (where m and n denote positive integers, respectively; for example, 2f2−1f1), the mobile terminal ML cannot typically receive a radio communication from the base station radio unit BS3 because of interference (or due to a fault) from the resulting inter-modulation.

In addition, in conventional radio communication network systems, for example, at a time of power-on or in a situation in which an interfering radio wave or signal comes in the communication area there are typically no provisions for the switching of the active communication frequency to avoid such interference. In such situations, there is a possibility that the frequency being allocated without considering the other frequencies being used by other base station radio units. Accordingly, the allocated frequency may interfere with the frequencies being used by the other base station units, resulting in the above-mentioned interference from inter-modulation or the like and resulting in a hindrance to communications between mobile terminals and base station radio units.

### SUMMARY OF THE INVENTION

Accordingly, it is an object of the present invention to provide a novel method, system and computer readable medium for a radio communication processing unit, wherein the setting, switching or allocation of a communication frequency for each of base station radio units does not interfere with communication frequencies being used by other base station units.

The above and other objects of the present invention are achieved by providing a novel radio communication processing unit which handles communication processing between each of mobile terminals and a host server connected to a network, with each of the plurality of mobile terminals being connected to at least one base station radio unit within a communication area of the base station radio unit connected thereto and existing within a radio communication network system in which a communication is established by wireless radio between the mobile terminals and the host server in a state where the base station radio unit intervenes therebetween. The radio communication processing unit includes a storage device for storing at least communication frequencies being used in all base station radio units existing within the radio communication network system; a frequency setting device for determining, on the basis of the contents stored in the storage device, a communication frequency for use in the base station radio unit connected to its own self to set the determined communication frequency in the base station radio unit; a reporting device for reporting channel information including information indicative of the base station radio unit connected to its own self and information indicative of the communication frequency being currently in use in the base station radio unit through the network system to each of different radio communication processing units; and a storage editing device for updating the contents stored in the storage device on the basis of the channel information given from the reporting device of the different radio communication processing unit.

With the above arrangement, advantageously, the respective radio communication processing units communicate the communication frequencies the base station radio units connected to the processing units are using currently to each other through the use of the reporting device and storage device to learn the communication frequencies being used by all the base station radio units existing in the radio communication network system. In this way, when setting a frequency to be used by the base station radio units connected to the network, each of the radio communication processing units can select a frequency which does not interfere with the communication frequencies being currently used by the base station radio units connected to the other radio communication processing units.

According to another feature of the present invention, the radio communication processing unit further includes a channel information requesting device for, when there arises a need to set or change a communication frequency to be used in the base station radio unit connected to its own self, outputting a channel information requesting signal to make a request for transmission of channel information on the base station radio unit connected to each of the different radio communication processing units, to all the different radio communication processing units, when receiving the channel information requesting signal from the channel information requesting device of the different radio communication processing unit, the reporting device referring to the contents of the storage device for transmitting the channel information on the base station radio unit connected to its own self to the channel information requesting signal issuing radio communication processing unit, and further the frequency setting device determining a communication frequency to be used in the base station radio unit connected to its own self, on the basis of the contents of the storage device updated in the storage editing device in accordance with each of the channel information transmitted from all the different radio communication processing units in response to a request from its own channel information request device.

With the above arrangement, advantageously, when there arises a need to set or change the communication frequency being used by the base station radio unit connected thereto, first, the channel information requesting device transmits a channel information requesting signal to all the other radio communication processing units. Furthermore, upon receipt of the channel information requesting signal, each of all the other radio communication processing units transmits the channel information in the base station radio unit connected thereto to the channel information requesting signal issuing radio communication processing unit. Accordingly, the channel information requesting signal issuing radio communication processing unit updates the contents in the storage device in accordance with each of the channel information sent from all the other radio communication processing units and determines, on the basis of the updated contents, a communication frequency to be used in the base station radio unit.

According to another feature of the present invention, in the radio communication processing unit, when there arises a need to set or change a communication frequency to be used in the base station radio unit connected to its own self, the frequency setting device determines a communication frequency, to be used in the base station radio unit connected to its own self, on the basis of the contents stored in the storage device, while the reporting device reports information on the channel information, determined by the frequency setting device, to be used in the base station radio unit connected to its own self to all the different radio communication processing units.

With the above arrangement, advantageously, when a need exists to set or change the communication frequency being used in the base station radio unit, a communication frequency to be used in the base station radio unit is first determined on the basis of the contents in the storage device, and the channel information depending upon the determined communication frequency is then communicated to all the other radio communication processing units. Accordingly, all the other radio communication processing units update the contents of their own storage device on the basis of the communicated channel information through use of their own storage editing device. In addition, when a need arises to set or change the communication frequency being used in the base station radio unit, such as when a power supply is turned on, a reset is asserted, or an interfering radio wave or signal enters the communication area of the base station radio unit, advantageously the communication frequency being used is switched.

According to another feature of the present invention, the radio communication processing unit, when determining a communication frequency to be used in the base station radio unit connected to its own self, the frequency setting device makes a frequency determination on a first condition that, of a plurality of predetermined communication frequencies, a communication frequency which is not being put to use in the base station radio unit existing on the periphery of the base station radio unit being a determined communication frequency using unit is determined as the communication frequency to be used therein, if there exist a plurality of communication frequencies falling under the first condition, the frequency setting device makes a frequency determination on a second condition that a communication frequency which does not cause interference due to inter-modulation is determined as the communication frequency to be used therein considering frequencies being used in the peripheral base station radio unit and in the base station radio unit existing on the periphery of the peripheral base station radio unit, and if there exist a plurality of communication frequencies falling under the second condition or if there exist a plurality of frequencies falling under the first condition but not falling under the second condition, the frequency setting device determines the highest communication frequency of the plurality of channels as the communication frequency to be used therein.

In another aspect of the present invention there is provided a novel computer-readable recording medium recording a radio communication processing program for handling communication processing between each of a plurality of mobile terminals and a host server connected to a network, with each of the plurality of mobile terminals being present within a radio communication network system in which a communication is made by wireless radio between each of the mobile terminals and the host server in a state where base station radio units intervenes therebetween, and with the radio communication processing program being run by a communication processing computer connected to at least one base station radio unit, and even with each of the mobile terminals existing in a communication area of the base station radio unit connected to the communication processing computer. The radio communication program making the communication processing computer fulfill functions of storing, in a storage device, at least communication frequencies being used in all the base station radio units existing within the radio communication network system; determining, on the basis of the contents stored in the storage device, a communication frequency for use in the base station radio unit connected to its own unit to set the determined communication frequency in the base station radio unit; reporting channel information including information indicative of the base station radio unit connected to its own unit and information indicative of a communication frequency being currently in use in the base station radio unit connected thereto through the network to a different radio communication processing unit; and updating the contents stored in the storage device on the basis of the channel information given from a reporting device of the different radio communication processing unit.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram schematically illustrating a configuration of a radio communication network system in which radio communication processing units according to embodiments of this invention are applicable;

FIG. 2 is a block diagram schematically illustrating a configuration of a channel selection instructing section of a radio communication processing unit, according to an embodiment of the present invention;

FIG. 3 is a table used for describing the contents stored in a channel information storage section of a channel selection instructing section of a radio communication processing unit of FIG. 2, according to the present invention;

FIG. 4 is a block diagram schematically illustrating a configuration of a channel selection instructing section of a radio communication processing unit of FIG. 2, further including a device for notifying another radio server of channel information when a channel changing instruction is issued manually, according to the present invention;

FIG. 5 is a block diagram schematically illustrating a configuration of a channel selection instructing section of a radio communication processing unit, according to another embodiment of the present invention;

FIG. 6 is a table used for describing the contents stored in a channel information storage section of a channel selection instructing section of a radio communication processing unit of FIG. 5, according to the present invention; and

FIGS. 7(a) and 7(b) are illustrations for explaining interference due to inter-modulation in a radio communication network system.

### DETAILED DESCRIPTION OF THE PREFERRED EMBODIMENTS

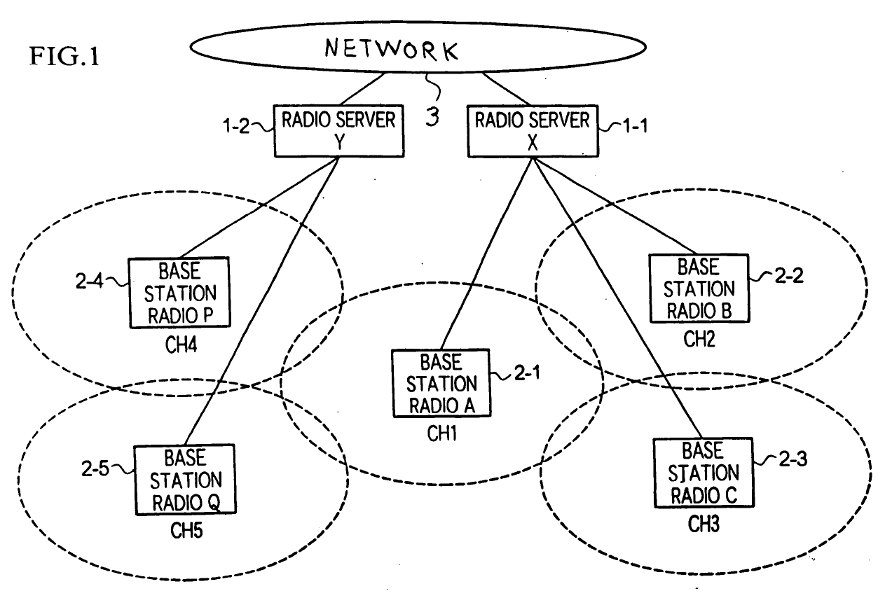

Referring now to the drawings, wherein like reference numerals designate identical or corresponding parts throughout the several views, and more particularly to FIG. 1 thereof, there is illustrated a block diagram schematically showing a configuration of a radio communication network system to which radio communication processing units (also referred to as “radio servers”) according to embodiments of the present invention are applicable.

In FIG. 1, reference numerals 1-1 and 1-2 designate radio servers connected to a network 3, with the radio server 1-1 being named X while the radio server 1-2 being named Y. Numerals 2-1 to 2-5 denote base station radio units, with the base station radio units 2-1 to 2-3 being connected to the radio server 1-1, while the base station radio units 2-4 and 2-5 being connected to the radio server 1-2. The base station radio units 2-1 to 2-5 are named A, B, C, P and Q, respectively. Each of the base station radio units 2-1 to 2-5 is in connection with a mobile terminal(s) (not shown) existing in the communication area (i.e., an area indicated by a dotted line surrounding each of the base station radio units 21- to 2-5 in FIG. 1) thereof. In this case, the communication area of each of the base station radio units 2-1 to 2-5 is determined as a range area corresponding to a distance within which the base station radio unit can receive a radio wave transmitted from a mobile terminal (not shown).

In addition, the frequencies (hereinafter referred to as “channels”) which can be used by the above-mentioned base station radio units 2-1 to 2-5 to communicate with the respective mobile terminal (not shown), are represented as six channels CH1 to CH6, respectively. Each of the base station radio units 2-1 to 2-5 uses any one of these channels CH1 to CH6 to establish a communication with each of mobile terminals existing within its own communication area.

In the above-noted radio communication network system, the radio server 1-1 manages communications between each of mobile terminals lying in each of the communication areas of the base station radio units 2-1 to 2-3 and a host server (not shown) connected to the network 3. On the other hand, the radio server 1-2 manages communications between each of mobile terminals existing in each of the communication areas of the base station radio units 2-4 and 2-5 and the host server (not shown) connected to the network 3.

That is, each of the radio servers 1-1 and 1-2, when a mobile terminal comes in the communication area of the base station radio unit (hereinafter referred to as a “subordinate base station radio unit”) it manages, (i) conducts a registration certifying operation for the mobile terminal, (ii) an IP address issuing operation, or the like and (iii) then controls data communications between a host computer (not shown) connected to the network 3 and the mobile terminal.

In addition, each of the radio servers 1-1 and 1-2 further functions to set a channel to be used and gives a channel switching instruction to its own subordinate base station radio units. Further, each of the radio servers 1-1 and 1-2 has a section (hereinafter referred to as a “channel selection instructing section”) for realizing the above function, with its configuration including a storage means storing at least the channels being used (hereinafter referred to as an “active channel”) in all the base station radio units existing in the radio communication network system and further including a frequency setting means for determining a channel to be used in each of the subordinate base station radio units on the basis of the contents stored in this storage means to set the determined channel in each of the subordinate base station radio units 2-1 to 2-5.

Thus, each of the base station radio units 2-1 to 2-5 establishes a communication with a mobile terminal existing within its own communication area through the use of the channel set by the frequency setting means of the respective managing radio server 1-1 or 1-2. In this case, each of the radio servers 1-1 and 1-2 determines a channel to be assigned to the subordinate base station radio units using the following channel selection conditions:

(1) a channel is selected which is not active in peripheral base station radio units;

(2) if there are a plurality of channels falling under the condition (1), then a channel which does not cause interference due to inter-modulation is selected in consideration of the active channels in peripheral (i.e., adjacent) base station radio units and in the base station radio units (hereinafter referred to as “secondary peripheral base station radio units”) existing on the periphery of the peripheral base station radio units; and

(3) if there are a plurality of channels falling under the condition (2), or if a plurality of channels coming under the condition (1) exist and have a possibility of causing the interference resulting from the inter-modulation, of the plurality of channels, the channel having the highest frequency is selected.

In addition, each of the radio servers 1-1 and 1-2 includes a reporting means for reporting channel information, including information indicative of its subordinate base station radio units and information indicative of active communication frequencies in the subordinate base station radio units, through the network 3 to the other radio servers. Additionally, each of the radio servers 1-1 and 1-2 includes a storage editing means to update the contents stored in the storage means on the basis of the channel information given from the reporting means of the other radio servers.

Thus, the radio server 1-1 notifies the radio server 1-2 of the channel information of its subordinate base station radio units 2-1, 2-2 and 2-3, while the radio server 1-2 communicates the channel information of the its subordinate base station radio units 2-4 and 2-5 to the radio server 1-1. In addition, each of the radio servers 1-1 and 1-2 updates the channel for use in each of the base station radio units, stored in the storage means, on the basis of the channel information communicated therefrom.

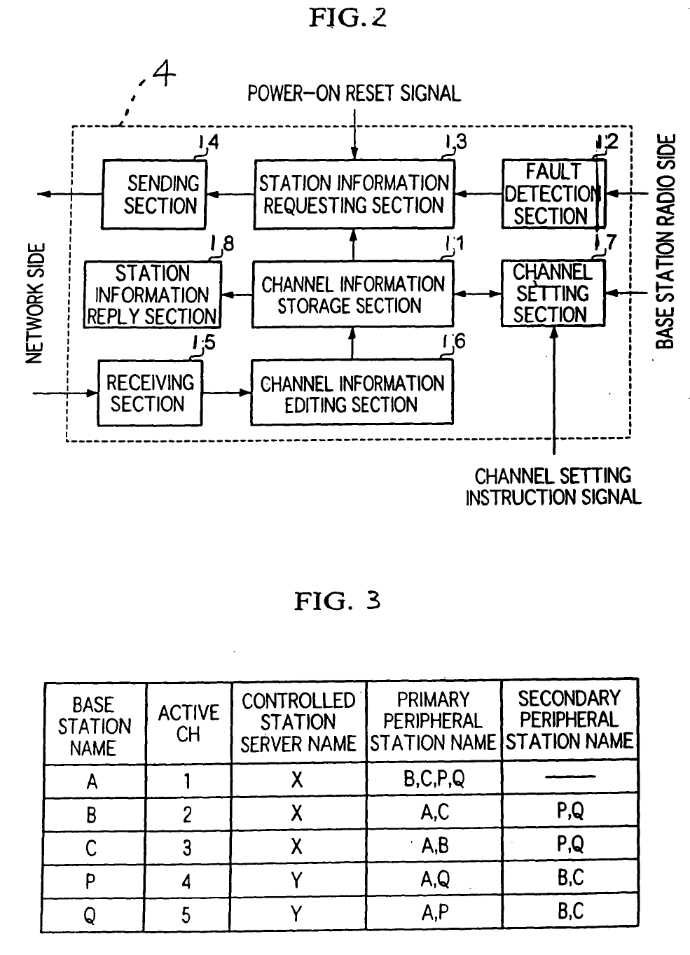

Secondly, referring to FIGS. 2 to 6, a description will be given hereinbelow of a more concrete configuration of the above-mentioned channel selection instructing section in each of the radio servers.

### First Embodiment

FIG. 2 is a block diagram schematically showing a configuration of a channel selection instructing section, denoted as numeral 4, in each of the radio servers 1-1 and 1-2 according to a first embodiment of this invention. In FIG. 2, reference numeral 11 depicts a channel information storage section which, as shown in FIG. 3, stores, in relation to each of the base station radio units 2-1 to 2-5 (e.g., “A”, “B”, “C”, “P” and “Q”) under the item “BASE STATION NAME”, (1) channels being used currently under the item “ACTIVE CH”, (2) managing server names under the item “CONTROLLED STATION SERVER NAME”), (3) peripheral base station radio unit names under the item “PRIMARY PERIPHERAL STATION NAME” and (4) secondary peripheral base station radio unit names under the item “SECONDARY PERIPHERAL STATION NAME”. In the above-noted configuration, for example, a non-volatile memory or the like can be employed as the channel information storage section 11. The contents of the aforesaid items (1) to (4) are predetermined but not altered.

In addition, in FIG. 2 numeral 12 denotes a fault detection section for detecting a fault occurring within the communication areas of the subordinate base station radio terminals and further recognizing the name of the base station radio unit in which the fault has occurred. Numeral 13 denotes a station (i.e., base station radio unit) information requesting section which, if receiving a power-on signal for when the power supply of the radio server to which it pertains is turned on, if receiving a reset signal for when the radio server to which it pertains is reset, or if the fault detection section 12 has detected a fault, refers to the contents stored in the channel information storage section 11 for outputting a channel information requesting signal to advance a request for information (hereinafter referred to as “channel information”) indicative of the names of the subordinate base station radio units and representative of the active channels (i.e., the channels being used) to all the other radio servers.

Numeral 14 denotes a sending section for transmitting the channel information requesting signal output from the station information requesting section 13 to the network 3. Numeral 15 represents a receiving section for receiving channel information transmitted from the other radio servers through the network 3, a channel information requesting signal transmitted from the other radio servers and other information and signals.

Numeral 16 denotes a channel information editing section for, when the receiving section 15 receives channel information sent from the other radio server in response to a channel information requesting signal outputted from the station information requesting section 13 of the radio server to which it pertains, updating (i.e., editing) the contents of the item “ACTIVE CH” in the channel information storage section 11 on the basis of that channel information. Incidentally, if the channel information has not been sent from the other radio server in response to the channel information requesting signal output from the station information requesting section 13, then the updating of the information about the active channel in the subordinate base station radio unit of that radio server does not take place.

Numeral 17 denotes a channel setting section for, when the channel information editing section 16 has updated the contents of the channel information storage section 11, determining a channel to be set or a channel to be switched to and for giving an instruction about the determined channel to each of the subordinate base station radio units. In addition, when the operator designates a subordinate base station radio unit and inputs a channel setting instruction signal indicative of a channel to be used in that base station radio unit, the channel setting section 17 sets the active channel of the designated base station radio unit in accordance with the contents of the channel setting instruction signal. Further, upon the completion of the setting of a channel, in the channel information storage section 11, the contents of the item “ACTIVE CH” on the base station radio unit related to the instruction about the change of the channel given by the operator is updated to the set channel.

Numeral 18 denotes a station (i.e., base station radio unit) information reply section which, when the receiving section 15 has received a channel information requesting signal from the other radio server, refers to the contents stored in the channel information storage section 11 for transmitting the channel information of each of the subordinate base station radio units of the radio server, to which it pertains, through the receiving section 14 to the radio server which transmitted the aforesaid channel information requesting signal.

A description of the operation of the above-described channel selection instructing section will now be given. First of all, the description will start at an operation to be conducted when, for example, the radio server 1-2 is in operation and the power supply of the radio server 1-1 is turned on (i.e., power-on). In this case, let it be assumed that the channels the base station radio units 2-4 and 2-5 subordinate to the radio server 1-2 are using are CH4 and CH5, respectively, while the channels the base station radio units 2-1, 2-2 and 2-3 subordinate to the radio server 1-1 were using immediately before the turning-off of the power supply (i.e., power-off) of the radio server 1-1 are CH1, CH2 and CH3, respectively. In addition, let it be assumed that the channel CH6 is not being used by any base station radio unit 2-1 to 2-5.

Upon the power-on of the radio server 1-1, on the basis of the contents in the channel information storage section 11, the station information requesting section 13 transmits a channel information requesting signal related to the base station radio units 2-4 and 2-5 through the sending section 14 to the radio server 1-2. Hence, in the radio server 1-2, the station information reply section 18 refers to the channel information storage section 11 for reading out the active channels of the subordinate base station radio units 2-4 and 2-5 to send the read active channel information together with the name of each of the base station radio units as channel information through the sending section 14 to the radio server 1-1.

Subsequently, in the radio server 1-1, upon receipt of this channel information by the receiving section 15, the channel information editing section 16 updates the active channel information for the base station radio units 2-4 and 2-5 in the channel information storage section 11. On the completion of this updating, the channel setting section 17 determines channels for the base station radio units 2-1, 2-2 and 2-3 on the basis of the updated contents in the channel information storage section 11.

That is, the channel setting section 16 of the radio server 1-1 selects the channels for the base station radio units 2-1, 2-2 and 2-3, which do not interfere with the active channels in the subordinate base station radio units of the radio server 1-2, according to the above-mentioned conditions (1) to (3), and communicates the selected channels to the corresponding base station radio units 2-1, 2-2 and 2-3. A method of selecting the channels which do not interfere with the active channels of the base station radio units subordinate to the radio server 1-2 will be later described. The above-mentioned operation similarly applies to the case in which a reset signal is input to the station information requesting section 13 of the radio server 1-1.

A description will now be given of an operation to be conducted when a fault occurs in the communication area of a base station radio unit. The description will be made of the case in which, for example, the fault detection section 12 in the radio server 1-1 has detected a fault occurring in the communication area of the base station radio unit 2-1 (e.g., whose active channel is CH1). In this case, first, on the basis of the contents of the channel information storage section 11, the station information requesting section 13 of the radio server 1-2 inquires from the radio server 1-2 about the channels being used currently (i.e., active channels) in the base station radio units 2-4 and 2-5.

Accordingly, in the radio server 1-2, in response to the aforesaid inquiry the receiving section 15 receives, the station information reply section 18 reads out the active channels in the base station radio units 2-4 and 2-5 stored in the channel information storage section 11 and transmits the channel information of each of the base station radio units subordinate to the radio server 1-2 through the sending section 14 to the radio server 1-1.

Following this, the receiving section 15 of the radio server 1-1 receives this channel information, and the channel information editing section 16 updates (i.e., edits) the contents of the channel information storage section 11. Thereafter, the channel setting section 17 makes a decision on (i.e., finds) a channel not being used in the peripheral base station radio units on the basis of the updated contents of the channel information storage section 11 (i.e., the foregoing channel selection condition (1)). In this case, since the channel in which the fault occurred is CH1 and the channels being used in the base station radio units 2-2, 2-3, 2-4 and 2-5 existing on the periphery of the base station radio unit 2-1 are CH2, CH3, CH4 and CH5, respectively, the inactive channel is CH6 only.

Thus, the channel setting section 17 gives an instruction for use of the channel CH6 to the base station radio unit 2-1. In addition, the channel setting section 17 changes the active channel of the base station radio unit 2-1 from CH1 to CH6 in the channel information storage section 11.

A description will now be given of the case in which, in the above-mentioned state, the fault detection section 12 in the radio server 1-2 detects a fault occurring in the communication area of the base station radio unit 2-4 (e.g., whose active channel is CH4). In this case, first, on the basis of the contents of the channel information storage section 11, the station information requesting section 13 in the radio server 1-2 inquires from the radio server 1-1 about the channels being used currently in the base station radio units 2-1, 2-2 and 2-3.

Accordingly, in the radio server 1-1, in response to the aforesaid inquiry received through the receiving section 15, the station information reply section 18 refers to the contents of the channel information storage section 11 for transmitting the channel information on each of the base station radio units 2-1 to 2-3 through the sending section 14 to the radio server 1-2.

Furthermore, in the radio server 1-2, the receiving section receives this channel information, and the channel setting section 17 makes a decision on a channel not being used in the peripheral base station radio units (i.e., the foregoing channel selection condition (1)). In this case, because the channel in which the fault occurred is CH4 and the active channels of the base station radio units 2-1 and 2-5 existing on the periphery of the base station radio unit 2-4 are CH6 and CH5, respectively, the available channels are CH1 to CH3.

Following this, the channel setting section 17 selects, of the available channels CH1 to CH3, a channel which does not undergo the inter-modulation interference with the active channels of the other base station radio units (i.e., the foregoing channel selection condition (2)). Concretely, in the case of the above-mentioned state, the channel setting section 17 selects a channel which is not subjected to the inter-modulation interference occurring with the following combinations of two channels:

a) the channel CH5 (e.g., the active channel of the base station radio unit 2-5) and the channel CH6 (e.g., the active channel of the base station radio unit 2-1);

b) the channel CH5 and the channel CH2 (e.g., the active channel of the base station radio unit 2-2);

c) the channel CH5 and the channel CH3 (e.g., the active channel of the base station radio unit 2-3);

d) the channel CH6 and the channel CH2;

e) the channel CH6 and the channel CH3; and

f) the channel CH2 and the channel CH3.

In addition, if, of the available channels CH1 to CH3, there is only one channel which does not undergo the inter-modulation interference occurring with the aforesaid channel combinations, the channel setting section 17 of the radio server 1-2 gives instructions for the use of that channel to the base station radio unit 2-4. On the other hand, if, of the available channels CH1 to CH3, there are a plurality of channels which do not receive the influence of the inter-modulation distortion arising with the aforesaid channel combinations, or if every channel is subjected to the inter-modulation interference arising with the aforesaid channel combinations, the channel setting section 17 gives instructions for the use of the highest-frequency channel of these plurality of channels to the base station radio unit 2-4 (i.e., the foregoing channel selection condition (3)).

A description will now be given of the case in which an operator of a radio server changes the active channel of a base station radio unit manually. For the description, as an example, let it be assumed that, in the radio communication network system shown in FIG. 1, the active channel of the base station radio unit 2-1 is CH1, the active channel of the base station radio unit 2-2 is CH2, the active channel of the base station radio unit 2-3 is CH3, the active channel of the base station radio unit 2-4 is CH4 and the active channel of the base station radio unit 2-5 is CH5, and the operator changes the active channel of the base station radio unit 2-3 manually.

In this instance, there is a need for the operator to have full knowledge of the channels being used in the peripheral base station radio units and secondary peripheral base station radio units of the base station radio unit 2-3, besides there is a need for the operator to set a channel which does not interfere with the active channels of the peripheral base station radio units and the secondary peripheral base station radio units. For this reason, the operator has to set the channel CH6 as the channel to be used in the base station radio unit 2-3.

In this case, the operator inputs an instruction for the change of the channel of the base station radio unit 2-3 to the channel CH6 through the use of a keyboard or the like in the radio server 1-1 managing the base station radio unit 2-3. Hence, a channel setting instruction signal including the contents of this instruction is inputted to the channel setting section 17 in FIG. 2. In response to the input of this channel setting instruction signal, the channel setting section 17 issues instructions for the use of the channel CH6 to the base station radio unit 2-3.

In addition, the channel setting section 17 updates the contents of the item “ACTIVE CH” on the base station radio unit 2-3 in the channel information storage section 11 from the channel CH3 to the channel CH6. Thus, if the radio server 1-2 issues a channel information requesting signal afterwards, the radio server 1-1 will send the channel CH6 as the channel being used currently in the base station radio unit 2-3 to the radio server 1-2.

Incidentally, in the case of changing the active channel of a base station radio unit manually as stated above, it is also appropriate that the channel setting section 17 gives an instruction on the channel to be used in the base station radio unit designated by the operator to that base station radio unit to update the contents of the channel information storage section 11, before notifying the other radio servers of the information about the channel indicated.

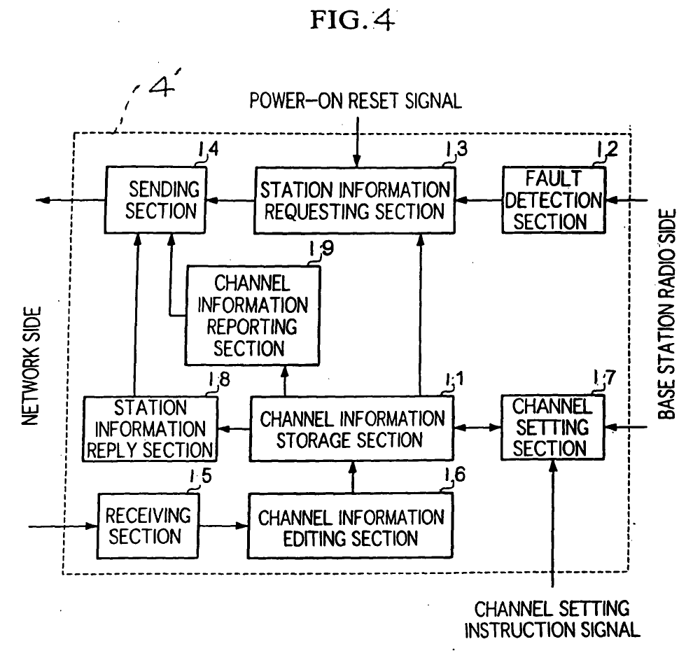

For realizing such a function, for example, as shown in FIG. 4, in a channel selection instructing section 4′, a channel information reporting section 19 is provided which, when the channel setting section 17 gives instructions on a channel to be used in the base station radio unit designated by the operator to that base station radio unit to update the contents of the channel information storage section 11, reports the updated channel information on the base station radio unit through the sending section 14 to all the other radio servers.

Thus, in the other radio servers, when receiving the channel information from the channel information reporting section 19 through the receiving section 15, the channel information editing section 16 updates the contents of the item “ACTIVE CH” on the base station radio unit, designated manually by the operator for the channel change, in their own channel information storage section 11.

### Second Embodiment

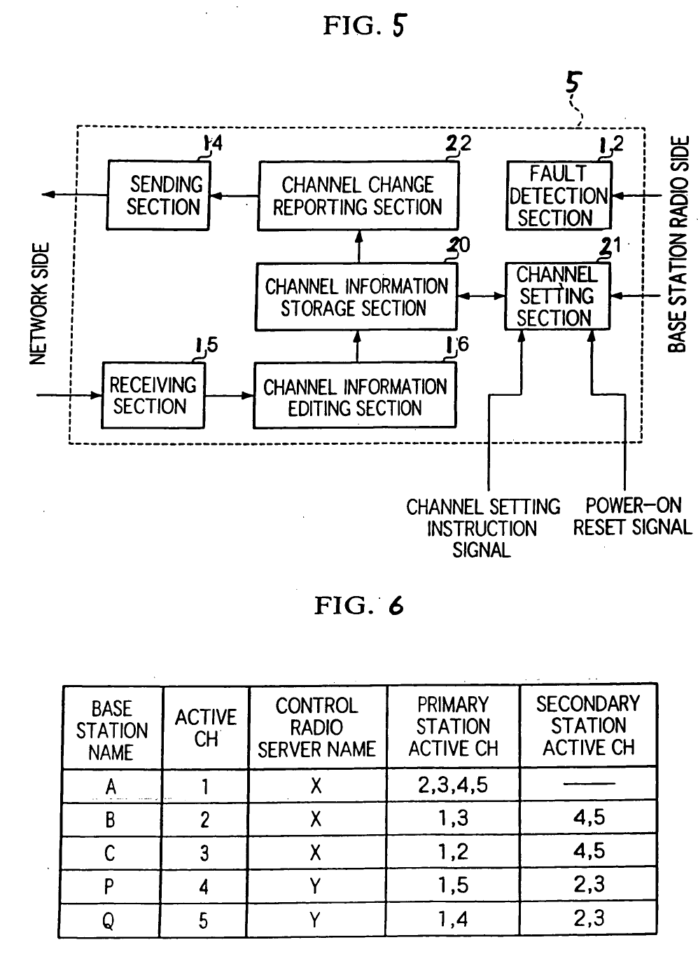

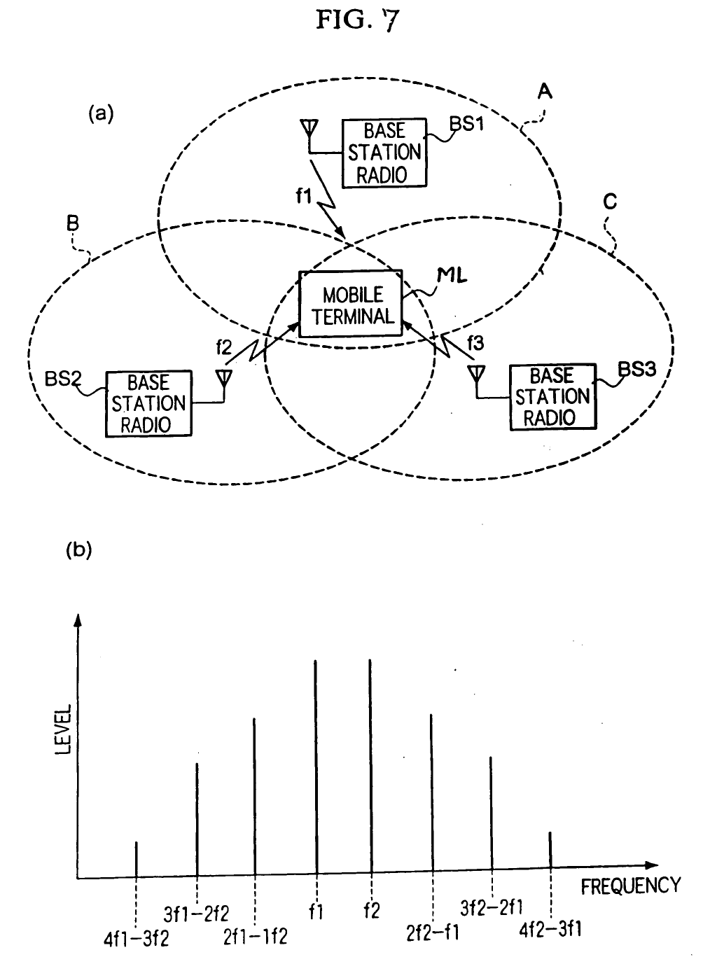

Referring to FIGS. 5 and 6, a description will now be given of a channel selection instructing section in each of radio servers according to a second embodiment of the present invention. Although in the channel selection instructing section according to the first embodiment, before an instruction for the setting or change of a channel is given to its own subordinate base station radio units, the information about the channels being used in the base station radio units subordinate to the other radio servers is collected, this embodiment differs therefrom in that, after an instruction for the setting or change of a channel is given to its own subordinate base station radio units, the information about the channel designated is reported to the other radio servers.

FIG. 5 is a block diagram schematically showing a configuration of a channel selection instructing section, denoted at numeral 5, according to the second embodiment of the present invention. In this illustration, the parts corresponding those in FIG. 2 are marked with the same reference numerals, and the description thereof will be omitted for brevity. The difference of the configuration in FIG. 5 from that in FIG. 2 is as follows.

Numeral 20 denotes a channel information storage section, which, as shown in FIG. 6, stores, in relation to each of the base station radio units 2-1 to 2-5 (e.g., “A”, “B”, “C”, “P” and “Q”) under the item “BASE STATION NAME”), (1) channels being used currently under the item “ACTIVE CH”, (2) managing server names under the item “CONTROL RADIO SERVER NAME”, (3) channels being used in peripheral base station radio units under the item “PRIMARY STATION ACTIVE CH” and (4) channels being used in secondary peripheral base station radio units under the item “SECONDARY STATION ACTIVE CH”. As in the channel information storage section 11 shown in FIG. 2, the channel information storage section 20 may be implemented using a non-volatile memory or the like.

Numeral 21 denotes a channel setting section which, when a power-on signal or a reset signal is input or when the fault detection section 12 detects a fault, such as an interfering radio wave or signal in a subordinate base station radio unit, determines a channel to be set or to be switched to and gives an instruction as to the determined channel to each of the subordinate base station radio units.

Numeral 22 denotes a channel change reporting section which, when the channel setting section 21 gives an instruction for the setting or switching to a channel to be used to a subordinate base station radio unit, refers to the contents of the channel information storage section 20 for reporting the channel information related to this subordinate base station radio unit through the sending section 14 to all the other radio servers connected to the network 3.

A description will now be given of an operation of the channel selection instructing section 5 shown in FIG. 5. This description will be made of an operation to be conducted in the case in which, for example, the radio server 1-2 is in operation and the power supply of the radio server 1-1 is turned on. In this case, let it be assumed that the active channels of the base station radio units 2-4 and 2-5 subordinate to the radio server 1-2 are CH4 and CH5, respectively, and the channels used in its own subordinate base station radio units 2-1, 2-2 and 2-3 immediately before the power supply of the radio server 1-1 is turned off are CH1, CH2 and CH3, respectively. Additionally, let it be assumed that the channel CH6 is not in use by any base station radio unit.

First, when the power supply of the radio server 1-1 is turned on so that a power-on signal is input to the channel setting section 21, the channel setting section 21 gives an instruction for the use of the channel stored in the channel information storage section 20 and used immediately before the previous turning-off of the subordinate base station radio unit. In this case, since the channels used immediately before the power-off in the base station radio units 2-1, 2-2 and 2-3 are CH1, CH2 and CH3, respectively, instructions as to these channels are given to the respective subordinate base station radio units.

In addition, on the completion of the aforesaid instruction from the channel setting section 21, the channel change reporting section 22 refers to the contents of the channel information storage section 20 for reporting the information on the channels set in the subordinate base station radio units through the sending section 14 to the other radio servers.

On the other hand, in the radio server 1-2 which is already active, when the channel information editing section 16 receives the channel information from the radio server 1-1 through the receiving section 15, the contents about the active channels of the base station radio units 2-1, 2-2 and 2-3 are updated in the channel information storage section 20.

Incidentally, the above-mentioned operation applies similarly to the case in which a reset signal is input to the channel setting section 20 of the radio server 1-1.

A description will now be given of an operation to be conducted when a fault occurs in the communication area of a base station radio unit being managed. For example, in a case in which the fault detection section 12 of the radio server 1-1 detects a fault occurring in the communication area of the base station radio unit (e.g., whose active channel is CH1), on the basis of the contents of the channel information storage section 20, the channel setting section 21 instructs the base station radio unit 2-1 of the channel to be switched to. In this case, because the peripheral base station radio units 2-2 to 2-5 are using CH2 to CH5, respectively, and the base station radio unit 2-1 has used the channel CH1, an instruction for the use of the spare channel CH6 is given to the base station radio unit 2-1.

In addition, the channel setting section 21 changes the stored portions corresponding to the channel CH1 in each item in the channel information storage section 20. That is, in the “ACTIVE CH” field corresponding to item A in the “BASE STATION NAME” and in the “PRIMARY STATION ACTIVE CH” fields corresponding to items B, C, P and Q in “BASE STATION NAME”, the “1 ” is changed to “6”.

Upon completion of the above-noted updating operation in the channel information storage section 20, the channel change reporting section 22 communicates the change of the active channel to the channel CH6 in the base station radio unit 2-1 through the sending section 14 to the radio server 1-2. Thus, in the radio server 1-2, the channel information editing section 16 updates the contents related to the active channel of the base station radio unit 2-1 from the channel CH1 to the channel CH6 in the channel information storage section 20.

A description will now be given hereinbelow of a case in which, in the above-mentioned state, the fault detection section 12 in the radio server 1-2 detects a fault occurring in the communication area of the base station radio unit 2-5 (e.g., whose active channel is CH5). In this case, first, on the basis of the contents of the channel information storage section 20, the channel setting section 21 in the radio server 1-2 makes a decision about a channel being inactive in the peripheral base station radio units (i.e., the foregoing channel selection condition (1)).

In this instance, since the channel in which the fault occurred is CH5 and the active channels of the base station radio units (i.e., base station radio units 2-1 and 2-4) existing on the periphery of the base station radio unit 2-5 are CH6 and CH4, the channels CH1 to CH3 form the available channels.

Subsequently, the channel setting section 21 selects, of the available channels CH1 to CH3, a channel which does not undergo the inter-modulation interference by the active channels of the other base station radio units (i.e., the foregoing channel selection condition (2)). That is, in the above-mentioned case, a channel is selected which is not affected by the inter-modulation distortion occurring with the following two-channel combinations:

a) the channel CH4 (the active channel of the base station radio unit 2-4) and the channel CH6 (the active channel of the base station radio unit 2-1);

b) the channel CH4 and the channel CH2 (the active channel of the base station radio unit 2-2);

c) the channel CH4 and the channel CH3 (the active channel of the base station radio unit 2-3);

d) the channel CH6 and the channel CH2;

e) the channel CH6 and the channel CH3; and

f) the channel CH2 and the channel CH3.

In addition, if, of the available channels CH1 to CH3, there is only one channel which does not undergo the inter-modulation interference occurring with the aforesaid channel combinations, the channel setting section 21 of the radio server 1-2 gives instructions for the use of that channel to the base station radio unit 2-5. On the other hand, if, of the available channels CH1 to CH3, there are a plurality of channels which do not receive the influence of the inter-modulation distortion arising with the aforesaid channel combinations, or if every channel is subjected to the inter-modulation interference arising with the aforesaid channel combinations, the channel setting section 21 gives instructions for the use of the highest-frequency channel of these plurality of channels to the base station radio unit 2-5 (i.e., the foregoing channel selection condition (3)).

Further, the channel setting section 21 changes the stored portions related to the old channel to those of the assigned channel that the channel setting section 21 has instructed the base station radio unit 2-4 of, in each of the items in the channel information storage section 20. That is, in the item “ACTIVE CH” for the “BASE STATION NAME” Q, in the item “PRIMARY STATION ACTIVE CH” for the “BASE STATION NAME” A and P and in the item “SECONDARY STATION ACTIVE CH” for the “BASE STATION NAME” B and C, the values “5” are changed to the values of the channel the channel setting section 21 has instructed the base station radio unit 2-4 of.

Following this, the channel change reporting section 22 reports the channel information after the change instruction, related to the base station radio unit 2-5 through the sending section 14 to the radio server 1-1. Accordingly, in the radio server 1-1, the channel information editing section 16 changes the portions stored as the channel CH5 in each of the items in the channel information storage section 20 to the reported channel.

A description will now be given of a case in which, in the channel selection instructing section 5, the operator of a radio server manually changes the channel to be used in a base station radio unit. For the description only, as an example, in the radio communication network system shown in FIG. 1, let it be assumed that the active channel of the base station radio unit 2-1 is CH1, the active channel of the base station radio unit 2-2 is CH2, the active channel of the base station radio unit 2-3 is CH3, the active channel of the base station radio unit 2-4 is CH4 and the active channel of the base station radio unit 2-5 is CH5 and the operator changes the active channel of the base station radio unit 2-3 manually.

In the case of the manual change of the active channel of a base station radio unit, there is a need for the operator to fully know the channels being used in the peripheral base station radio units existing on the periphery of the base station radio unit 2-3 and further in the secondary peripheral base station radio units around the peripheral base station radio units and additionally to set a channel which does not interfere with the active channels of the peripheral base station radio units and the secondary peripheral base station radio units. Therefore, with the above-noted channel allocation, the operator must select channel CH6 as an active channel to be set in the base station radio unit 2-3.

In this case, the operator inputs an instruction for changing the channel of the base station radio unit 2-3 to the channel 6 through the use of a keyboard or the like in the radio server 1-1 managing the base station radio unit 2-3. Thus, a channel setting instruction signal including the contents of the aforesaid instruction is input to the channel setting section 21 in FIG. 5. Upon receipt of this channel setting instruction signal, the channel setting section 21 issues an instruction for the use of the channel CH6 to the base station radio unit 2-3.

In addition, the channel setting section 21 updates the portions stored as the channel CH3 to the channel CH6 in each of the items in the channel information storage section 20. Further, upon completion of the above-noted updating operation, the channel change reporting section 22 reports the channel information on the base station radio unit 2-3 through the sending section 14 to the radio server 1-2 while, in the radio server 1-2, the channel information editing section 16 updates the portions stored as the channel CH3 to the channel CH6 in each of the items in the channel information storage section 20.

As described above, in the channel selection instructing section 5 according to the second embodiment, a radio server first gives an instruction for setting or changing of a channel to the base station radio units subordinate thereto, and then the other servers update the information on the channel set or changed. Thus, for example, when the power supply of one radio server is turned off, in the other radio servers, the updating of the information on the channels being used in the base station radio units subordinate to the radio servers does not take place.

Therefore, while the power supply of the aforesaid one radio server is turned off, in the other radio servers, at the channel change for the subordinate base station radio units, a channel is selected which does not interfere with the active channels of the base station radio units subordinate to the one radio server. Hence, when the power supply of the one radio server is turned on again, even if instructions for the use of the channels which have been used immediately before the power-off are given to the subordinate base station radio units, the channels do not interfere with the active channels of the base station radio units subordinate to the other radio servers.

Thus, unlike the first embodiment, in the channel selection instructing section according to this embodiment, there is no need to make a selection decision on the channels for the subordinate base station radio units for setting instruction.

It is also appropriate that a program for realizing the processing functions as described with respect to FIGS. 1 to 6 is recorded on a recording medium readable by a computer and the computer reads out the program recorded in this recording medium for fulfilling the functions to manage/control the frequencies to be used for communications between base station radio units and mobile terminals.

The term “computer system” is a term including hardware such as OSs and peripheral devices. Additionally, the term “computer-readable recording medium” signifies storage devices, such as floppy disks, magneto-optical disks, ROMs, CD-ROMs, and hard disks to be incorporated into computers. Still additionally, the term “computer-readable recording medium”, for example, includes communication lines to be used in transmitting the program through a network such as the Internet or a communication circuit such as a telephone circuit, which dynamically retain the program for a short time, and further includes volatile memories in the interior of a computer system constituting a server or client, which retain the program for a given period of time.

In addition, the foregoing program can also be for realizing a portion of the aforesaid functions, or it can also be designed to realize the functions in corporation with the programs already stored in a computer system.

For example, in a case in which a need arises to set or change the communication frequency being used in a base station radio unit connected to its own communication processing computer, it is also appropriate that, with a program for realizing the aforesaid functions, the communication processing computer is operated to realize a channel information requesting function for outputting, to other communication processing computers, a channel information requesting signal for making a request for the transmission of the channel information on the base station radio units connected to the other communication processing computers, or that, upon receipt of a channel information requesting signal from the other communication processing computer, the communication processing computer is driven to realize a function to send the channel information on the base station radio units connected thereto to the channel information requesting signal sending communication processing computer for updating the information on the communication frequencies being used in all the base station radio units existing within the radio communication network system in accordance with each of the channel information sent from all the other communication processing computers in response to the request by its own channel information requesting function and further to determine communication frequencies to be used in the base station radio units connected thereto on the basis of the updated information.

In addition, when there arises a need to set or change an active communication frequency of a base station radio unit connected to its own communication processing computer, it is also appropriate that, with the foregoing program, the aforesaid communication processing computer is operated to realize a function to determine a communication frequency to be used in the base station radio unit connected to its own communication processing computer on the basis of the information, already stored, on the communication frequencies being used in all the base station radio units existing within the radio communication network system and subsequently to report the determined channel information on the base station radio unit to all the other communication processing computers.

Further, it is also appropriate that, when determining a communication frequency to be used in a base station radio unit connected thereto, the foregoing program makes the aforesaid communication processing computer selectively determine, as the frequency to be used, a communication frequency not being used by the base station radio units existing on the periphery of the communication frequency determination base station radio unit from a plurality of predetermined communication frequencies according to a first condition, and if there are a plurality of communication frequencies falling under the first condition, determine, as the communication frequency to be used, a communication frequency which does not cause the interference due to inter-modulation in consideration of the communication frequencies being used in the peripheral base station radio units and in the base station radio units existing on the periphery of the peripheral base station radio units according to a second condition, and further, when there are a plurality of communication frequencies falling under the second condition or when every communication frequency does not fall under the second condition, determine, as the communication frequency to be used, the highest communication frequency of these plurality of channels.

As described above, according to this invention, a plurality of radio communication processing units report the communication frequencies being used, by the base station radio units connected thereto, to each other. In this way, the processing units can store the communication frequencies being used by all the base station radio units lying within a radio communication network system. Then when the processing units set a frequency to be used in each of the base station radio units connected thereto, they can select a communication frequency which does not interfere with the communication frequencies being used in the base station radio units connected to the other radio communication units, advantageously resulting in stable data communications in a radio communication network system.

The mechanisms and processes set forth in the present description may be implemented using a conventional general purpose microprocessor or computer programmed according to the teachings in the present specification, as will be appreciated to those skilled in the relevant art(s). Appropriate software coding can readily be prepared by skilled programmers based on the teachings of the present disclosure, as will also be apparent to those skilled in the relevant art(s). However, as will be readily apparent to those skilled in the art, the present invention also may be implemented by the preparation of application-specific integrated circuits or by interconnecting an appropriate network of conventional component circuits.

The present invention thus also includes a computer-based product (or computer readable recording media) which may be hosted on a storage medium and include instructions which can be used to program a microprocessor to perform a process in accordance with the present invention. This storage medium can include, but is not limited to, any type of disk including floppy disks, optical disks, CD-ROMs, magneto-optical disks, ROMs, RAMs, EPROMs, EEPROMs, flash memory, magnetic or optical cards, etc., or any type of media suitable for storing electronic instructions.

In addition, it is assumed herein that a computer system according to the present invention includes, for example, an Operating System (OS) and related hardware, such as peripheral devices and the like. The computer readable recording media refers to (i) any transportable media, such as floppy disks, a magneto-optical disks, ROMs, CD-ROMs and the like, and storage devices, such as hard disks, etc., that are installed in the computer system, (ii) media that hold a program dynamically for a short period of time, such as a communication line in case of transmitting the program through a network, such as the Internet, a communication line, such as a telephone line and (iii) media the hold a program for a certain period of time, such as a volatile memory inside a computer system that becomes a server or a client, etc. Further, the above-mentioned computer program may implement a portion of the functions described above and/or may enable implementing the functions described above in combination with another computer program.

Obviously, numerous additional modifications and variations of the present invention are possible in light of the above teachings. It is therefore to be understood that within the scope of the appended claims, the present invention may be practiced otherwise than as specifically described herein.

This document claims priority and contains subject matter related to Japanese Patent Application Hei 11-002359 filed on Jan. 7, 1999, the entire contents of which are hereby incorporated by reference.

What is claimed as new and is desired to be secured by letters patent of the United States is:

1. A radio communication processing unit which handles communication processing between each of mobile terminals and a host server connected to a network, with each of said plurality of mobile terminals being connected to at least one base station radio unit within a communication area of said base station radio unit connected thereto and existing within a radio communication network system in which a communication is established by wireless radio between said mobile terminals and said host server in a state where said base station radio unit intervenes therebetween, said radio communication processing unit comprising:
storage means for storing at least communication frequencies being used in all base station radio units existing within said radio communication network system;
frequency setting means for determining, on the basis of the contents stored in said storage means, a communication frequency for use in said base station radio unit connected to its own self to set the determined communication frequency in said base station radio unit;
reporting means for reporting channel information including information indicative of said base station radio unit connected to its own self and information indicative of said communication frequency being currently in use in said base station radio unit through said network system to each of different radio communication processing units; and
storage editing means for updating the contents stored in said storage means on the basis of said channel information given from said reporting means of said different radio communication processing unit.

2. The radio communication processing unit according to claim 1, further comprising channel information requesting means for, when there arises a need to set or change a communication frequency to be used in said base station radio unit connected to its own self, outputting a channel information requesting signal to make a request for transmission of channel information on said base station radio unit connected to each of said different radio communication processing units, to all said different radio communication processing units,
when receiving said channel information requesting signal from said channel information requesting means of said different radio communication processing unit, said reporting means referring to the contents of said storage means for transmitting said channel information on said base station radio unit connected to its own self to said channel information requesting signal issuing radio communication processing unit, and further said frequency setting means determining a communication frequency to be used in said base station radio unit connected to its own self, on the basis of the contents of said storage means updated in said storage editing means in accordance with each of said channel information transmitted from all said different radio communication processing units in response to a request from its own channel information request means.

3. The radio communication processing unit according to claim 1, wherein, when there arises a need to set or change a communication frequency to be used in said base station radio unit connected to its own self, said frequency setting means determines a communication frequency, to be used in said base station radio unit connected to its own self, on the basis of the contents stored in said storage means,
while said reporting means reports information on said channel information, determined by said frequency setting means, to be used in said base station radio unit connected to its own self to all said different radio communication processing units.

4. The radio communication processing unit according to claim 1, wherein, when determining a communication frequency to be used in said base station radio unit connected to its own self, said frequency setting means makes a frequency determination on a first condition that, of a plurality of predetermined communication frequencies, a communication frequency which is not being put to use in said base station radio unit existing on the periphery of said base station radio unit being a determined communication frequency using unit is determined as said communication frequency to be used therein,
if there exist a plurality of communication frequencies falling under said first condition, said frequency setting means makes a frequency determination on a second condition that a communication frequency which does not cause interference due to inter-modulation is determined as said communication frequency to be used therein considering frequencies being used in said peripheral base station radio unit and in said base station radio unit existing on the periphery of said peripheral base station radio unit, and
if there exist a plurality of communication frequencies falling under said second condition or if there exist a plurality of frequencies falling under said first condition but not falling under said second condition, said frequency setting means determines the highest communication frequency of said plurality of channels as said communication frequency to be used therein.

5. The radio communication processing unit according to claim 2, wherein, when determining a communication frequency to be used in said base station radio unit connected to its own self, said frequency setting means makes a frequency determination on a first condition that, of a plurality of predetermined communication frequencies, a communication frequency which is not being put to use in said base station radio unit existing on the periphery of said base station radio unit being a determined communication frequency using unit is determined as said communication frequency to be used therein,
if there exist a plurality of communication frequencies falling under said first condition, said frequency setting means makes a frequency determination on a second condition that a communication frequency which does not cause interference due to inter-modulation is determined as said communication frequency to be used therein considering frequencies being used in said peripheral base station radio unit and in said base station radio unit existing on the periphery of said peripheral base station radio unit, and
if there exist a plurality of communication frequencies falling under said second condition or if there exist a plurality of frequencies falling under said first condition but not falling under said second condition, said frequency setting means determines the highest communication frequency of said plurality of channels as said communication frequency to be used therein.

6. The radio communication processing unit according to claim 3, wherein, when determining a communication frequency to be used in said base station radio unit connected to its own self, said frequency setting means makes a frequency determination on a first condition that, of a plurality of predetermined communication frequencies, a communication frequency which is not being put to use in said base station radio unit existing on the periphery of said base station radio unit being a determined communication frequency using unit is determined as said communication frequency to be used therein,
if there exist a plurality of communication frequencies falling under said first condition, said frequency setting means makes a frequency determination on a second condition that a communication frequency which does not cause interference due to inter-modulation is determined as said communication frequency to be used therein considering frequencies being used in said peripheral base station radio unit and in said base station radio unit existing on the periphery of said peripheral base station radio unit, and
if there exist a plurality of communication frequencies falling under said second condition or if there exist a plurality of frequencies falling under said first condition but not falling under said second condition, said frequency setting means determines the highest communication frequency of said plurality of channels as said communication frequency to be used therein.

7. A computer-readable recording medium recording a radio communication processing program for handling communication processing between each of a plurality of mobile terminals and a host server connected to a network, with each of said plurality of mobile terminals being present within a radio communication network system in which a communication is made by wireless radio between each of said mobile terminals and said host server in a state where base station radio units intervenes therebetween, and with said radio communication processing program being run by a communication processing computer connected to at least one base station radio unit, and even with each of said mobile terminals existing in a communication area of said base station radio unit connected to said communication processing computer, said radio communication program making said communication processing computer fulfill functions of:
storing, in storage means, at least communication frequencies being used in all said base station radio units existing within said radio communication network system;
determining, on the basis of the contents stored in said storage means, a communication frequency for use in said base station radio unit connected to its own unit to set the determined communication frequency in said base station radio unit;
reporting channel information including information indicative of said base station radio unit connected to its own unit and information indicative of a communication frequency being currently in use in said base station radio unit connected thereto through said network to a different radio communication processing unit; and
updating the contents stored in said storage means on the basis of the channel information given from reporting means of said different radio communication processing unit.
